(19) United States
(12) Patent Application Publication
(10) Pub. No.: US 2001/0019586 A1
(43) Pub. Date: Sep. 6, 2001

(54) Motion estimation method and device

(76) Inventors: Hyun Soo Kang, Seoul (KR); Kyeong Joong Kim, Seoul (KR); Jae Won Chung, Seoul (KR)

Correspondence Address: MERCHANT & GOULD, P O BOX 2903, MINNEAPOLIS, MN, 55402-0903, US

(21) Appl. No.: 09/782,552

(22) Filed: Feb. 13, 2001

(30) Foreign Application Priority Data
Feb. 22, 2000 (KR) 2000-8513

(51) Int. Cl. H04N 7/12

(52) U.S. Cl. 375/240.16; 375/240.24

(57) ABSTRACT

A motion estimation method and device for selecting a final motion vector to be coded, in consideration of a zero vector and a predicted motion vector as well as a motion vector having a minimum error, thereby increasing a video coding efficiency.

### BACKGROUND OF THE INVENTION

1. Field of the Invention

The present invention relates in general to a motion estimation device in a digital video compression coding system and a method thereof, and more particularly to a motion estimation method and device for selecting a final motion vector to be coded, in consideration of a zero vector and a predicted motion vector as well as a motion vector having a minimum error, thereby increasing the coding efficiency.

2. Description of the Prior Art

Generally, video signal compression coding and decoding can desirably reduce the capacity of a memory necessary for storing image information as well as transmit the image information over a low-rate channel. In this regard, such compression coding and decoding techniques occupy a very important part of the multimedia industry requiring a variety of image applications such as image storage, image transmission, etc.

FIG. 1 is a schematic block diagram showing the construction of a conventional video coding system. For the efficient video compression coding, there is generally used a method for estimating a motion vector using a reference frame for the coding of a current frame, performing a motion compensated prediction operation using the estimated motion vector and coding the resulting prediction error. With reference to FIG. 1, the conventional video coding system comprises a transform unit 20 for performing a transform operation for a frame difference between an input frame and a motion compensated prediction frame obtained by a motion compensation predictor 10, a quantizer 30 for quantizing transform coefficients from the transform unit 20 for data compression, a variable length coder 40 for performing a variable length coding (VLC) operation for the transform coefficients quantized by the quantizer 30, a dequantizer 50 and an inverse transform unit 60. In this coding system, the frame difference is reconstructed by the dequantizer 50 and inverse transform unit 60 and applied to the motion compensation predictor 10 for the next frame prediction. On the other hand, the motion compensation predictor 10 performs a motion vector estimation operation using the input frame and the reference frame and finds the prediction frame using an estimated motion vector. The motion compensation predictor 10 also performs a motion compensated prediction operation and transfers the estimated motion vector to the variable length coder 40, which then variable length codes and transmits it together with the transform coefficients quantized by the quantizer 30. An image information bit stream output from the variable length coder 40 is transmitted to a receiver or a multiplexer for its multiplexing with other signals.

In a general video coding method and system, motion prediction and compensation operations are not performed on a frame basis, but in the unit of a predetermined number of picture elements or pixels (M pixels in the horizontal direction and N pixels in the vertical direction, typically indicated by M×N pixels). This group of pixels is typically called a macroblock. It is generally prescribed that the macroblock be sized with 16 pixels in the horizontal direction and 16 pixels in the vertical direction (referred to hereinafter as “16×16”). In the present invention, although the size of the macroblock is not limited to a specific value, it will be described as 16×16 as an example for the convenience of description. A motion vector is two-dimensional information indicative of the quantity of motion of an object in the reference and current frames on two-dimensional X-Y coordinates. Namely, the motion vector consists of a transversal motion value and a longitudinal motion value.

FIG. 2 is a detailed block diagram of the motion compensation predictor 10 in the conventional video coding system of FIG. 1. As shown in this drawing, the motion compensation predictor 10 includes a motion compensation unit 11 for performing a motion compensation operation, a motion estimation unit 12 for performing a motion vector estimation operation, and a previous image reconstruction unit 13 for obtaining a reconstructed version of the previous frame to be used to obtain the motion compensated prediction frame. Although the previous frame is used as the reference frame in FIG. 2, the next frame may be used as the reference frame for an increase in prediction efficiency in any other coding system. The previous image reconstruction unit 13 obtains a reconstructed version of the coded frame by adding the reconstructed version of the frame difference transferred from the inverse transform unit 60 to a previous reconstructed frame stored therein. The reconstructed frame obtained by the previous image reconstruction unit 13 is then used as an input to the motion estimation unit 12 for the motion estimation of the subsequent input frame. The motion estimation unit 12 performs the motion vector estimation operation for the coding of the current frame on the basis of an output from the previous image reconstruction unit 13 and the input frame and outputs the resulting motion vector, which is then transferred to the variable length coder 40 for its variable length coding. The variable length coder 40 can code input values with a much smaller number of bits than fixed length coding (FLC) by assigning a smaller number of bits to a value with a higher generation frequency and a larger number of bits to a value with a lower generation frequency, respectively. On the other hand, the motion vector output from the motion estimation unit 12 is applied to the motion compensation unit 11, which then performs the motion compensation operation using the applied motion vector and thus finally produces the prediction frame.

As stated previously, the motion vector estimation operation is performed on a macroblock basis. This motion vector estimation signifies a procedure for searching a previous frame for a portion most similar to a current frame block. A conventional motion vector estimation method does not utilize information of macroblocks surrounding a macroblock of a current frame, but searches a previous frame for a portion most similar to the current frame macroblock.

A motion vector has a close correlation with the surrounding blocks or macroblocks because of image characteristics. Accordingly, the coding efficiency can be increased by variable length coding a difference vector between a current motion vector and a motion vector predicted using motion vectors of the surrounding blocks or macroblocks, rather than directly variable length coding the current motion vector. The reason is that the difference vector is 0 or a value approximate to 0 at a significantly high frequency.

Generally, a predicted motion vector can be determined using adjacent motion vectors in the following manner. Namely, the predicted motion vector is determined as the median value of motion vectors of the left, upper and upper right blocks or macroblocks around a current block or macroblock. A difference vector between the determined predicted motion vector and the current motion vector is obtained and then variable length coded. This method is typically used in ITU-T H.263 and ISO/IEC MPEG-4.

FIG. 3 is a view illustrating motion vectors of the left, upper and upper right blocks or macroblocks around a macroblock to be currently coded, when the current macroblock is in a 16×16 mode. In this drawing, MVa can be interpreted to be of two types. It represents a motion vector of the left macroblock if the left macroblock is in the 16×16 mode, and a motion vector of a block positioned above the right-hand side of the left macroblock if the left macroblock is in an 8×8 mode. Similarly, MVb represents a motion vector of the upper macroblock if the upper macroblock is in the 16×16 mode, and a motion vector of a block positioned below the left-hand side of the upper macroblock if the upper macroblock is in the 8×8 mode. Similarly, MVc represents a motion vector of the upper right macroblock if the upper right macroblock is in the 16×16 mode, and a motion vector of a block positioned below the left-hand side of the upper right macroblock if the upper right macroblock is in the 8×8 mode.

A motion vector estimated in a general motion search manner has a value selected to minimize the motion compensated error, not considering the coding efficiency of the motion vector. For this reason, a bit stream of a coded motion vector may exhibit a considerable difference in size even when a motion compensated error has a slight difference. There is a conventional method for conducting no coding when motion compensated errors resulting from a motion vector estimated in a motion search method and a zero vector are below predetermined threshold values. However, this method is effective for only frames with little variations. In other words, it cannot effectively perform a motion estimation operation for frames with variations.

### SUMMARY OF THE INVENTION

Therefore, the present invention has been made in view of the above problems, and it is an object of the present invention to provide a motion estimation method and device for selecting a motion vector to increase the coding efficiency irrespective of an increase in motion compensated error, in a different manner from conventional motion estimation systems for selecting the motion vector to minimize the motion compensated error, thereby enhancing the entire efficiency of a coding system in terms of rate-distortion.

In accordance with one aspect of the present invention, the above and other objects can be accomplished by the provision of a motion vector estimation method comprising the first step of obtaining a predicted motion vector on the basis of motion vectors of blocks surrounding a block to be currently coded; the second step of searching for a motion vector with a minimum motion compensated error and, meanwhile, obtaining the minimum motion compensated error, a motion compensated error of a zero vector and a motion compensated error of the predicted motion vector; the third step of comparing the motion compensated error of the zero vector with a first predetermined threshold value; the fourth step of determining the zero vector as a final motion vector if it is determined at the above third step that the motion compensated error of the zero vector is smaller than the first predetermined threshold value; the fifth step of comparing the motion compensated error of the predicted motion vector with a second predetermined threshold value if it is determined at the above third step that the motion compensated error of the zero vector is not smaller than the first predetermined threshold value; the sixth step of determining the predicted motion vector as the final motion vector if it is determined at the above fifth step that the motion compensated error of the predicted motion vector is smaller than the second predetermined threshold value; and the seventh step of determining the motion vector with the minimum motion compensated error as the final motion vector if it is determined at the above fifth step that the motion compensated error of the predicted motion vector is not smaller than the second predetermined threshold value.

In accordance with another aspect of the present invention, there is provided a motion vector estimation device comprising a motion vector predictor for obtaining a predicted motion vector on the basis of motion vectors of blocks surrounding a block to be currently coded, stored in a motion vector memory; a motion vector searcher for searching for a motion vector with a minimum motion compensated error using a current frame and a reference frame and, meanwhile, obtaining the minimum motion compensated error, a motion compensated error of a zero vector and a motion compensated error of the predicted motion vector; a motion vector selector for receiving the motion vector with the minimum motion compensated error, the minimum motion compensated error, the motion compensated error of the zero vector and the motion compensated error of the predicted motion vector from the motion vector searcher, the predicted motion vector from the motion vector predictor and first and second threshold values and then determining a final motion vector using the received information; and the motion vector memory adapted to receive and store the final motion vector determined by the motion vector selector.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic block diagram showing the construction of a conventional video coding system;

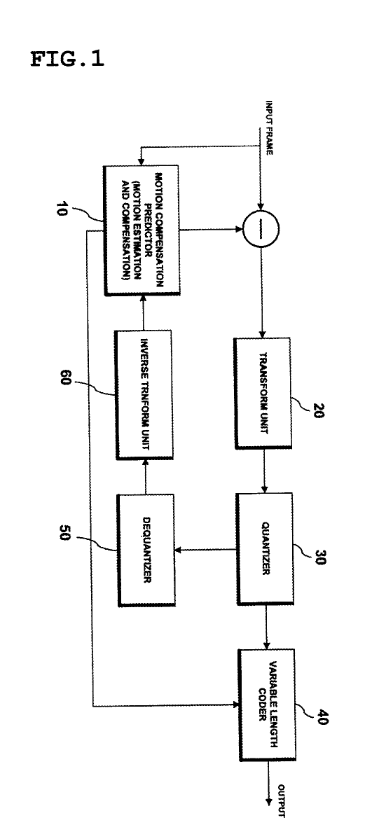

FIG. 2 is a detailed block diagram of a motion compensation predictor in the conventional video coding system of FIG. 1;

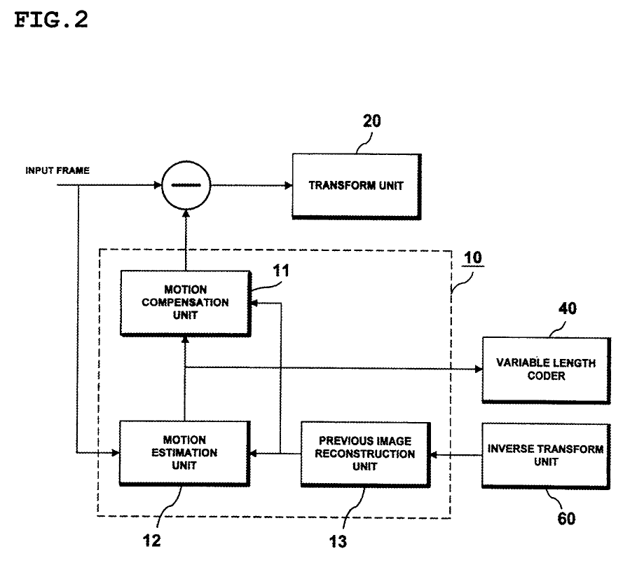

FIG. 3 is a view illustrating motion vectors of blocks around a macroblock to be currently coded, when the current macroblock is in a 16×16 mode;

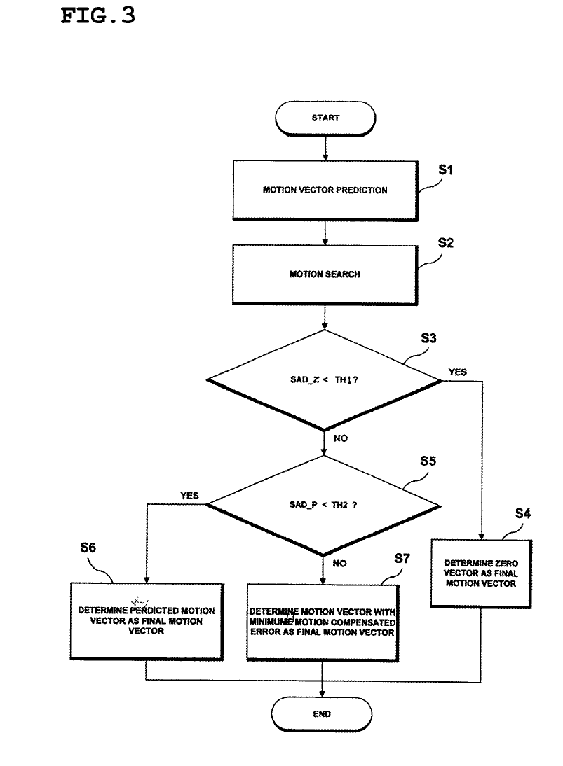

FIG. 4 is a flowchart illustrating a motion estimation method in accordance with the preferred embodiment of the present invention; and

FIG. 5 is a schematic block diagram showing the construction of a motion estimation device in accordance with the preferred embodiment of the present invention.

### DETAILED DESCRIPTION OF THE PREFERRED EMBODIMENTS

Abbreviations used in the specification can be defined as follows before describing the present invention in detail.

The reference character “MED( )” denotes a function for extracting the median value of elements in parentheses. For example, MED(1,3,7)=3.

The reference character “SAD” denotes the sum of absolute differences, which is an example of a motion compensated error used in the present invention.

The reference character “MVZ” denotes a zero vector (0,0).

The reference character “MVP” denotes a predicted motion vector obtained on the basis of the surrounding macroblocks.

The reference character “MVM” denotes a motion vector selected to minimize the motion compensated error.

The reference character “SAD_Z” denotes an SAD of one macroblock between a previous frame and a current frame, obtained on the basis of the zero vector MVZ.

The reference character “SAD_P” denotes an SAD of one macroblock between a previous frame and a current frame, obtained on the basis of MVP.

The reference character “SAD_M” denotes an SAD of one macroblock between a previous frame and a current frame, obtained on the basis of MVM.

Generally, a video coding system is adapted to perform a motion vector searching operation to calculate motion compensated errors of motion vectors within a searching range and select a motion vector having the minimum motion compensated error, from among the motion vectors. The present invention is characterized in that a motion estimation operation is performed on the basis of not only a motion vector with a minimum motion compensated error, but also a motion compensated error of a zero vector and a motion compensated error of a predicted motion vector obtained using a motion prediction process. In the case where the motion compensated error of the zero vector is sufficiently small (for example, below a first threshold value), a satisfactory picture quality can be obtained by using a previous frame directly without performing a coding operation. In this case, the coding efficiency becomes very high by performing no coding and transmitting a very short code indicative of the no-coding state. In the case where the motion compensated error of the zero vector is somewhat large (for example, above the first threshold value) and the motion compensated error of the predicted motion vector is somewhat small (for example, below a second threshold value), the predicted motion vector is coded and transmitted. Notably, the current motion vector itself is not actually coded, but a difference vector between the current motion vector and the predicted motion vector is variable length coded and transmitted. As a result, the difference vector becomes 0 if the predicted motion vector is selected. This difference vector of 0 is a symbol of the highest generation frequency, which is coded into the shortest bit stream and then transmitted, thereby significantly increasing the coding efficiency. In the case where the motion compensated error of the zero vector and the motion compensated error of the predicted motion vector are above a specific threshold value (for example, the second threshold value), the motion vector with the minimum motion compensated error, obtained during the motion estimation operation, is selected as the final motion vector and then coded.

In the present invention, the determination of the above-mentioned first and second threshold values is not limited to a particular method. Any method may be used to determine the first and second threshold values, as long as the second threshold value is set to be larger than the first threshold value. The first and second threshold values can be preset to have values determined to be of uniform high quality with respect to all frames through many experiments. Alternatively, these values may be adaptively calculated and used for a specific video signal during a digital video coding operation.

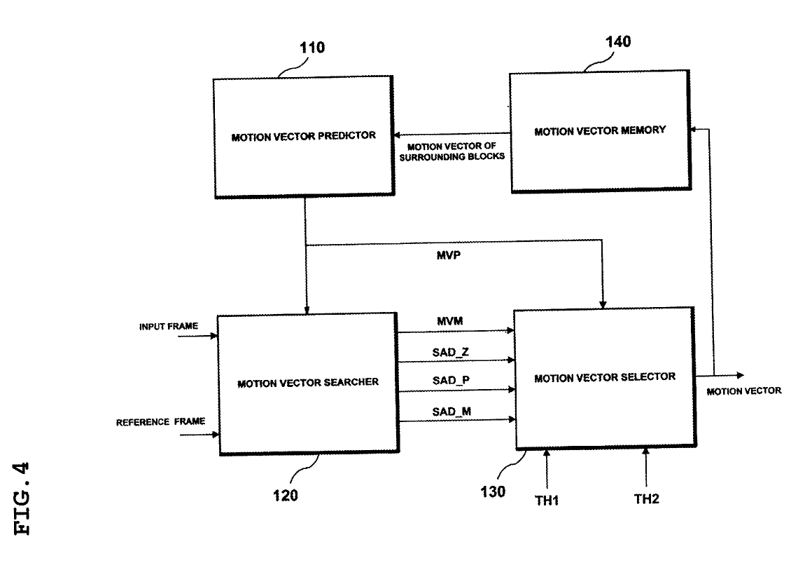

FIG. 4 is a flowchart illustrating a motion estimation method in accordance with the preferred embodiment of the present invention. The respective steps of the present motion estimation method can be performed in the below manner.

At the first step S1, a predicted motion vector MVP is obtained on the basis of motion vectors of blocks surrounding a block to be currently coded. In the present invention, a function for obtaining the predicted motion vector MVP is not limited to a particular function. For example, the predicted motion vector MVP may be obtained by taking the median value of motion vectors of blocks or macroblocks surrounding a block or macroblock to be currently coded, as in the following equation 1.

MVP=MED(MV1,MV2,MV3) [Equation 1]

where, MV1, MV2 and MV3 represent motion vectors of macroblocks surrounding a macroblock to be currently coded, respectively.

At the second step S2, a motion vector MVM having a minimum motion compensated error is searched for on the basis of the predicted motion vector MVP obtained the above first step S1. The minimum motion compensated error (e.g., SAD_M), a motion compensated error (e.g., SAD_Z) of a zero vector MVZ and a motion compensated error (e.g., SAD_P) of the predicted motion vector are also obtained at the second step S2. For example, assuming that a macroblock to be currently coded is in a 16×16 mode and a motion vector thereof is (x,y), an SAD (Sum of Absolute Difference) of one macroblock between a previous frame and a current frame may be obtained as a motion compensated error of the motion vector as in the following equation 2. It should be noted that the SAD is used as the motion compensated error in FIG. 4 for the convenience of description. In the present invention, the motion compensated error is not limited to the SAD.

$$SAD ( x , y ) = {\sum }_{i = 0}^{15} {\sum }_{j = 0}^{15} \vert p ( i , j ) - p ( i + x , j + y ) \vert \qquad \text{[Equation 2]}$$

It should also be noted that the search for a motion vector with a minimum compensated error within a given search area is not limited to a particular search method. In the present invention, all motion search methods including, for example, a full search, pyramidal search and three-step search can be used to search for a motion vector with a minimum compensated error.

In the present invention, in order to minimize a motion compensated error, a zero vector and a predicted motion vector can be contained within a given search range. Therefore, motion compensated errors of the zero vector and predicted motion vector are obtained not separately from a motion vector with a minimum motion compensated error, but automatically while the motion vector with the minimum motion compensated error is searched for.

At the third step S3, the motion compensated error SAD_Z of the zero vector MVZ obtained at the above second step S2 is compared with a first threshold value TH1. If SAD_Z is smaller than TH1, the fourth step S4 is performed to determine the zero vector MVZ as the final motion vector. Then, the motion estimation for the current macroblock is ended. On the other hand, if SAD_Z is not smaller than TH1, the fifth step S5 is performed.

At the fifth step S5, the motion compensated error SAD_P of the predicted motion vector MVP obtained at the above second step S2 is compared with a second threshold value TH2. If SAD_P is smaller than TH2, the sixth step S6 is performed to determine the predicted motion vector MVP as the final motion vector. Then, the motion estimation for the current macroblock is ended. However, if SAD_P is not smaller than TH2, the seventh step S7 is performed to determine the motion vector MVM with the minimum motion compensated error as the final motion vector. Then, the motion estimation for the current macroblock is ended.

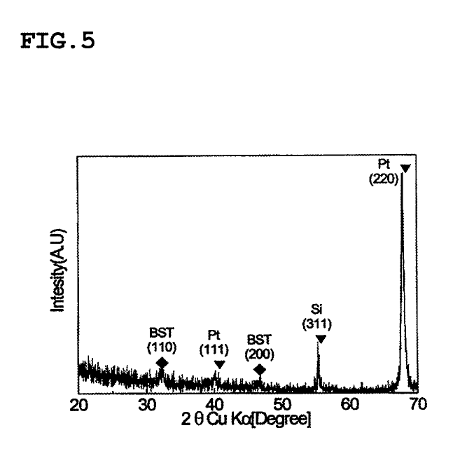

FIG. 5 is a schematic block diagram showing the construction of a motion estimation device in accordance with the preferred embodiment of the present invention. As shown in this drawing, the present motion estimation device comprises a motion vector predictor 110, motion vector searcher 120, motion vector selector 130 and motion vector memory 140.

In the motion estimation device of the present invention, the motion vector predictor 110 is adapted to obtain a predicted motion vector MVP on the basis of motion vectors of blocks surrounding a block to be currently coded, stored in the motion vector memory 140.

The motion vector searcher 120 is adapted to search for a motion vector with a minimum motion compensated error using an input frame and a reference frame and, meanwhile, obtain the minimum motion compensated error (e.g., SAD_M), a motion compensated error (e.g., SAD_Z) of a zero vector MVZ and a motion compensated error (e.g., SAD_P) of the predicted motion vector. In detail, the motion vector searcher 120 includes a first motion compensated error calculator for calculating the motion compensated error of the zero vector using the zero vector, the input frame and the reference frame, and a second motion compensated error calculator for calculating the motion compensated error of the predicted motion vector using the predicted motion vector, the input frame and the reference frame.

It should be noted that means for obtaining the motion vector with the minimum motion compensated error is not limited to specific search means. For example, the motion vector searcher 120 may be arbitrary search means such as full search means, pyramidal search means, three-step search means or four-step search means, as long as it can search for the motion vector MVM with the minimum motion compensated error within a given search area.

In the motion estimation device of the present invention, the motion vector selector 130 is adapted to receive the motion vector MVM with the minimum motion compensated error, the minimum motion compensated error SAD_M, the motion compensated error SAD_Z of the zero vector and the motion compensated error SAD_P of the predicted motion vector from the motion vector searcher 120, the predicted motion vector MVP from the motion vector predictor 110 and the first and second threshold values TH1 and TH2 and then determine the final motion vector using the received information.

The motion vector selector 130 includes a first comparator for comparing the motion compensated error of the zero vector from the first motion compensated error calculator with the first threshold value, a second comparator for comparing the motion compensated error of the predicted motion vector from the second motion compensated error calculator with the second threshold value, a first switch for enabling the second comparator or selecting the zero vector in accordance with the result compared by the first comparator, and a second switch for selecting one of the motion vector with the minimum motion compensated error, outputted from a third motion compensated error calculator, and the predicted motion vector in accordance with the result compared by the second comparator.

The first switch is adapted to select the zero vector as the final motion vector if the result compared by the first comparator indicates that the motion compensated error of the zero vector is smaller than the first threshold value, and enable the second comparator, otherwise. The second switch is adapted to select the predicted motion vector as the final motion vector if the result compared by the second comparator indicates that the motion compensated error of the predicted motion vector is smaller than the second threshold value, and the motion vector with the minimum motion compensated error as the final motion vector, otherwise.

The motion vector memory 140 is adapted to receive and store the final motion vector from the motion vector selector 130 and supply the motion vectors of the blocks surrounding the block to be currently coded, to the motion vector predictor 110.

It should be noted that the first and second threshold values are not limited to particular values as long as the second threshold value is set to be greater than the first threshold value. The first and second threshold values can be preset to have values determined to be of uniform high quality with respect to all frames through many experiments. As an alternative, these values may be adaptively calculated and used for a specific video signal during a digital video coding operation. In the present invention, the use of two threshold values is more meaningful than the setting thereof to particular values. Also, it should be noted that the present motion estimation device shown in FIG. 5 is a part of a digital video coder. Although not shown in FIG. 5, a controller controlling the entire operation of the coder is adapted to determine the first and second threshold values.

As apparent from the above description, the present invention provides a motion estimation method and device which can adaptively select a motion vector from among a zero vector, a predicted motion vector and a motion vector with a minimum motion compensated error using an appropriate weight in consideration of bit lengths of motion vectors generated together with motion compensated errors during a motion estimation operation. Therefore, the present invention has the effect of increasing a video coding efficiency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A motion vector estimation method comprising the steps of:
a) obtaining a predicted motion vector on the basis of motion vectors of blocks surrounding a block to be currently coded;
b) searching for a motion vector with a minimum motion compensated error and, meanwhile, obtaining the minimum motion compensated error, a motion compensated error of a zero vector and a motion compensated error of said predicted motion vector;
c) comparing said motion compensated error of said zero vector with a first predetermined threshold value;
d) determining said zero vector as a final motion vector if it is determined at said step c) that said motion compensated error of said zero vector is smaller than said first predetermined threshold value;
e) comparing said motion compensated error of said predicted motion vector with a second predetermined threshold value if it is determined at said step c) that said motion compensated error of said zero vector is not smaller than said first predetermined threshold value;
f) determining said predicted motion vector as said final motion vector if it is determined at said step e) that said motion compensated error of said predicted motion vector is smaller than said second predetermined threshold value; and
g) determining said motion vector with the minimum motion compensated error as said final motion vector if it is determined at said step e) that said motion compensated error of said predicted motion vector is not smaller than said second predetermined threshold value.

2. A motion vector estimation method as set forth in claim 1, wherein said step a) includes the step of determining a median value of motion vectors of macroblocks or blocks surrounding a macroblock to be currently coded, as said predicted motion vector, using the following equation 1.
MVP=MED(MV1,MV2,MV3) [Equation 1]
where, MV1, MV2 and MV3 represent the motion vectors of the macroblocks or blocks surrounding the macroblock to be currently coded, respectively.

3. A motion vector estimation method as set forth in claim 1, wherein said step b) includes the step of determining the sum of absolute differences of one macroblock between a previous frame and a current frame as each of said motion compensated errors using the following equation 2.
$$SAD ( x , y ) = {\sum }_{i = 0}^{15} {\sum }_{j = 0}^{15} \vert p ( i , j ) - p ( i + x , j + y ) \vert \qquad \text{[Equation 2]}$$

4. A motion vector estimation method as set forth in claim 1, wherein said step b) includes the step of searching for said motion vector with the minimum motion compensated error using any one of a full search method, a pyramidal search method, a three-step search method and a four-step search method.

5. A motion vector estimation device comprising:
a motion vector predictor for obtaining a predicted motion vector on the basis of motion vectors of blocks surrounding a block to be currently coded, stored in a motion vector memory;
a motion vector searcher for searching for a motion vector with a minimum motion compensated error using a current frame and a reference frame and, meanwhile, obtaining the minimum motion compensated error, a motion compensated error of a zero vector and a motion compensated error of said predicted motion vector;
a motion vector selector for receiving said motion vector with the minimum motion compensated error, said minimum motion compensated error, said motion compensated error of said zero vector and said motion compensated error of said predicted motion vector from said motion vector searcher, said predicted motion vector from said motion vector predictor and first and second threshold values and then determining a final motion vector using the received information; and
said motion vector memory adapted to receive and store the final motion vector determined by said motion vector selector.

6. A motion vector estimation device as set forth in claim 5, wherein said motion vector searcher includes:
a first motion compensated error calculator for calculating said motion compensated error of said zero vector using said zero vector, said current frame and said reference frame; and
a second motion compensated error calculator for calculating said motion compensated error of said predicted motion vector using said predicted motion vector, said current frame and said reference frame.

7. A motion vector estimation device as set forth in claim 6, wherein said motion vector selector includes:
a first comparator for comparing said motion compensated error of said zero vector from said first motion compensated error calculator with said first threshold value;
a second comparator for comparing said motion compensated error of said predicted motion vector from said second motion compensated error calculator with said second threshold value;
a first switch for enabling said second comparator or selecting said zero vector in accordance with the result compared by said first comparator; and
a second switch for selecting one of said motion vector with the minimum motion compensated error and said predicted motion vector in accordance with the result compared by said second comparator.

8. A motion vector estimation device as set forth in claim 7, wherein said first switch is adapted to select said zero vector as said final motion vector if said result compared by said first comparator indicates that said motion compensated error of said zero vector is smaller than said first threshold value, and enable said second comparator, otherwise.

9. A motion vector estimation device as set forth in claim 7, wherein said second switch is adapted to select said predicted motion vector as said final motion vector if said result compared by said second comparator indicates that said motion compensated error of said predicted motion vector is smaller than said second threshold value, and said motion vector with the minimum motion compensated error as said final motion vector, otherwise.

10. A motion vector estimation device as set forth in claim 5, wherein said motion vector predictor includes means for determining a median value of motion vectors of macroblocks or blocks surrounding a macroblock to be currently coded, as said predicted motion vector, using the following equation 1.
MVP=MED(MV1,MV2,MV3) [Equation 1]
where, MV1, MV2 and MV3 represent the motion vectors of the macroblocks or blocks surrounding the macroblock to be currently coded, respectively.

11. A motion vector estimation device as set forth in claim 5, wherein said motion vector searcher includes means for determining the sum of absolute differences of one macroblock between a previous frame and a current frame as each of said motion compensated errors using the following equation 2.
$$SAD ( x , y ) = {\sum }_{i = 0}^{15} {\sum }_{j = 0}^{15} \vert p ( i , j ) - p ( i + x , j + y ) \vert \qquad \text{[Equation 2]}$$

12. A motion vector estimation device as set forth in claim 5, wherein said motion vector searcher includes means for searching for said motion vector with the minimum motion compensated error using any one of a full search method, a pyramidal search method, a three-step search method and a four-step search method.
